(19) United States
(12) Patent Application Publication
(10) Pub. No.: US 2004/0148261 A1
(43) Pub. Date: Jul. 29, 2004

(54) Method, apparatus, and program for image processing with tampering detection, and a medium storing the program

(76) Inventor: Yasushi Abe, Yokohama-shi (JP)

Correspondence Address: DICKSTEIN SHAPIRO MORIN & OSHINSKY LLP, 2101 L STREET NW, WASHINGTON, DC, 20037-1526, US

(21) Appl. No.: 10/739,094

(22) Filed: Dec. 19, 2003

(30) Foreign Application Priority Data
Dec. 19, 2002 (JP) 2002-367853

(51) Int. Cl. G06F 17/60

(52) U.S. Cl. 705/57

(57) ABSTRACT

A method and apparatus of image processing includes an image obtainer and a tamper-evident image generator. The image obtainer obtains an image to be processed. The tamper-evident image generator generates a tamper-evident image by filling the image with dots arranged according to a pattern. A method and apparatus of tampering detecting includes an image reader, a tampering detector, and an output unit. The tampering detector divides the image into unit areas, counts a number of dots in each unit area, tests whether the dot number matches with a predetermined numeric group, and determines whether each unit area is tampered based on the test result.

Computer program products stored on a computer readable storage medium run on the image processing apparatus and tampering detecting apparatus execute the image processing method and tampering detecting method. A computer readable medium storing computer instructions performs the image processing and tamper detecting methods.

### FIELD OF INVENTION

The present invention relates to a technique of detecting fraudulent alternation of a printed material, and more particularly to a method, apparatus, and program for image processing, providing a tamper-evident printed material and for detecting fraudulent alternation of the printed material.

### BACKGROUND OF THE INVENTION

Japanese Patent No. 2695523, “Printed Matter Suitable for Preventing Copy”, describes a technique of printing a latent image of a character, a symbol, or a pattern, formed with halftone dots or a line screen. The latent image is printed in a single color with offset process, for example, and when this printed matter is copied, the latent image pattern appears on the copy. In this way, a duplicated product is quite obviously discriminated.

Japanese Patent Laid-Open Application Publications No. H11-98344, “Method and Device for Discriminating Fraudulent Alteration of Digital Image by Using Electronic Watermark”, describes a method of discriminating fraudulent alternation of a digital image by using electronic watermark.

### SUMMARY OF THE INVENTION

The present invention provides an image processing apparatus, method and related computer program product or medium for providing an image with tamper-evident feature which makes alternation to the image being distinguishable, and an apparatus, method, and computer program product or medium for a tampering detection apparatus which detects the alternation. In one exemplary embodiment, an image processing apparatus includes an image obtainer and a tamper-evident image generator. The image obtainer is configured to obtain image data of an image to be processed. The tamper-evident image generator is configured to generate a tamper-evident image by filling the image obtained by the image data obtainer with dots arranged according to a predetermined pattern. The above-mentioned image processing apparatus may further include an analyzer configured to analyze the image, and thereby the tamper-evident image generator fills the image with the predetermined pattern based on results of the analyzer. The tamper-evident image generator may fill areas of blank background of the image with dots arranged according to the predetermined pattern based on results of the analyzer. The predetermined pattern may be a background dot pattern which forms a background of the image. The image processing apparatus may further include a printer configured to print the tamper-evident image according to the image data generated by the tamper-evident image generator.

The image processing apparatus may further include a communicator configured to send the image data generated by the tamper-evident image generator to other apparatuses through either one of a channel and a network. The image processing apparatus may further include a switch configured to activate and inactivate operations of the tamper-evident image generator. The tamper-evident image generator may process designated areas of the image. The tamper-evident image generator may be configured to perform an adjustment to change a number of dots in each unit dot area of the image to either one of predetermined numeric groups in generating the predetermined pattern, and the image is segmented into a plurality of unit dot areas. The adjustment may be performed based on specific information. The specific information may include a pseudo-random number. The predetermined numeric groups may include even and odd numeric groups.

In one embodiment, a tampering detecting apparatus includes an image reader, a tampering detector, and an output unit. The image reader is configured to read an image. The tampering detector is configured to divide the image read by the image reader into a plurality of unit areas, to count a number of dots existing in each of the plurality of unit areas, to test whether the dot number counted matches with a predetermined numeric group, and to determine whether each of the plurality of unit area is tampered based on result by the test. The output unit is configured to output results of the tampering detector.

Further, in one embodiment, an image processing method includes obtaining image data of an image to be processed and generating a tamper-evident image by filling the image obtained by the obtaining step with dots arranged according to a predetermined pattern.

In one embodiment, a tampering detecting method includes the steps of reading, detecting, and outputting. The reading step reads an image. The detecting step detects tampering in the image by dividing the image read by the image reading step into a plurality of unit areas, counting a number of dots existing in each of the plurality of unit areas, testing whether the dot number counted matches with a predetermined numeric group, and determining whether each of the plurality of unit area is tampered based on result by the testing. The outputting step outputs results of the detecting step.

Further, in one embodiment, a computer program product stored on a computer readable storage medium and run on an image processing apparatus executes an image processing method, and a computer program product stored on a computer readable storage medium and run on an tampering detecting apparatus executes an tampering detecting method, as described above.

Further, in one embodiment, a computer readable medium storing computer instructions performs an image processing method, and a computer readable medium storing computer instructions performs an tampering detecting method, as described above.

### BRIEF DESCRIPTION OF THE DRAWINGS

A more complete appreciation of the disclosure and many of the attendant advantages thereof will be readily understood by reference to the following detailed description and the accompanying drawings, wherein:

FIG. 1 is a block diagram showing an image processing apparatus according to an exemplary embodiment of the present invention;

FIG. 2 is a flowchart showing an operational process of the apparatus shown in FIG. 1;

FIG. 3A shows an exemplary document image to be processed;

FIG. 3B shows the document image of FIG. 3A with a dotted pattern added overall;

FIG. 4A is an enlarged view of a part of the document image shown in FIG. 3A;

FIG. 4B is an example of alternation on the document image shown in FIG. 4A;

FIG. 4C is an example of the part of the document image in proper appearance in contrast with altered one shown in FIG. 4B;

FIG. 5 is a block diagram showing an image processing apparatus according to another exemplary embodiment of the present invention;

FIG. 6 is a flowchart showing an operational process of the apparatus shown in FIG.5;

FIG. 7A shows an exemplary document image to be processed;

FIG. 7B shows the document image of FIG. 7A with a dotted pattern added to several parts;

FIG. 8 is a block diagram showing an image processing apparatus according to another exemplary embodiment of the present invention;

FIG. 9 is a flowchart showing an operational process of the apparatus shown in FIG. 8;

FIG. 10 is an exemplary arrangement of a plurality of dots generated in a rectangular unit area;

FIG. 11 shows an exemplary process of adjusting dot numbers performed by the image processing apparatus shown in FIG. 8.

FIG. 12 is a block diagram showing a tampering detecting apparatus according to an exemplary embodiment of the present invention;

FIG. 13 is a flowchart showing an operational process of the apparatus shown in FIG. 12; and

FIG. 14 shows a detailed example of a tampering detecting process performed by the apparatus shown in FIG. 12.

### DETAILED DESCRIPTION OF THE INVENTION

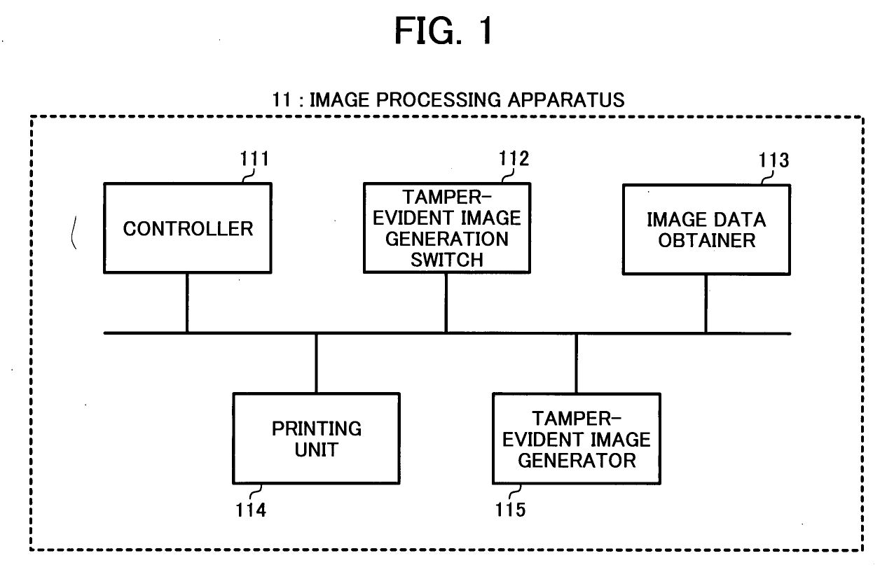

In describing preferred embodiments illustrated in the drawings, specific terminology is employed for the sake of clarity. However, the disclosure of the present invention is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIGS. 1-4, an image processing apparatus according to an exemplary embodiment of the present invention is described. In FIG. 1, the image processing apparatus 11 includes a controller 111, a tamper-evident image generation switch 112, an image data obtainer 113, a printing unit 114, and a tamper-evident image generator 115.

In this embodiment, the image processing apparatus 11 adds a tamper-evident dotted pattern to a document image to be processed, thereby allowing visual checking on the entire image for changes.

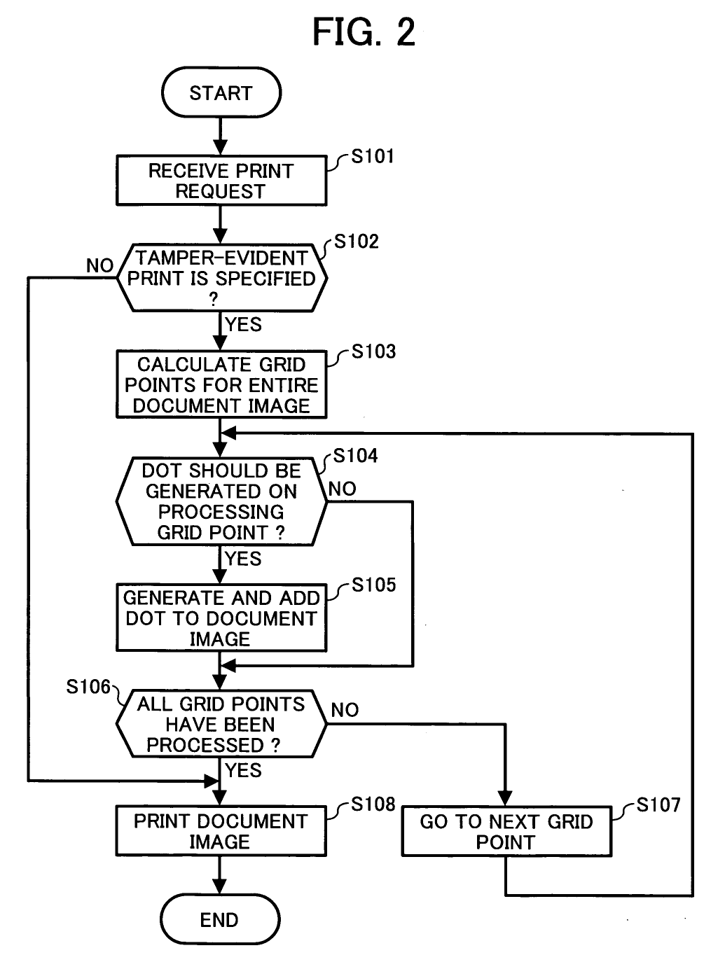

As shown in FIG. 2, the controller 111 receives a print request from a user in Step S101. The tamper-evident image generation switch 112 is able to set to the print request a command of printing a tamper-evident image. The image data obtainer 113 obtains image data to be processed. In Step S102, the controller 111 tests whether printing of a tamper-evident image is specified by the tamper-evident image generation switch 112.

When no specification is found to print the tamper-evident image, the operation proceeds to Step S108. In Step S108, the printing unit 114 prints the document image without an additional dotted image, and the operation proceeds to END.

When Step S102 determines to print the tamper-evident image, the operation proceeds to Step S103. In Step S103, the tamper-evident image generator 115 calculates positions of grid points in the entire document image and designates a grid point to be focused. In Step S104, the tamper-evident image generator 115 determines whether the grid point needs to be dotted. That is, when no image data exists on or close to the grid point, the tamper-evident image generator 115 determines to generate a dot on the grid point. In that case, the operation proceeds to Step S105 where the dot is added to the original document image. When there exists image data on or close to the grid point in Step S104, the tamper-evident image generator 115 determines as not to generate a dot on the grid point.

When the tamper-evident image generator 115 determines not to add the dot to the original image in Step S104, or an addition of the dot to the original image is completed in Step S105, the operation proceeds to Step S106. Step S106 tests whether all the grid points have been processed. When all the grid points have been processed, the operation proceeds to Step S108 to print the document image with an additional dot image, thereafter proceeds to END. In Step S106, when the process has not completed on all the grid points, the target moves to a next grid point, and the operation returns to Step S104.

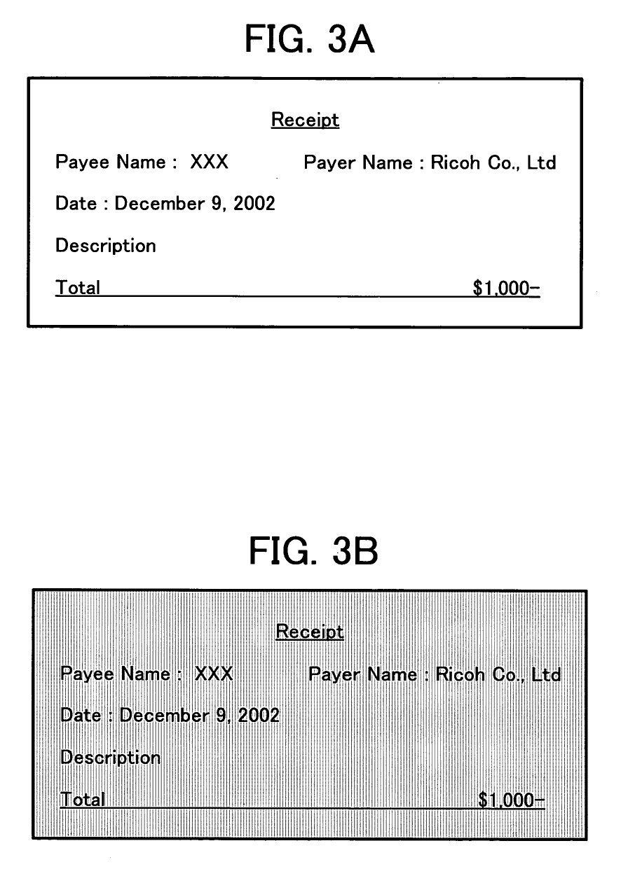

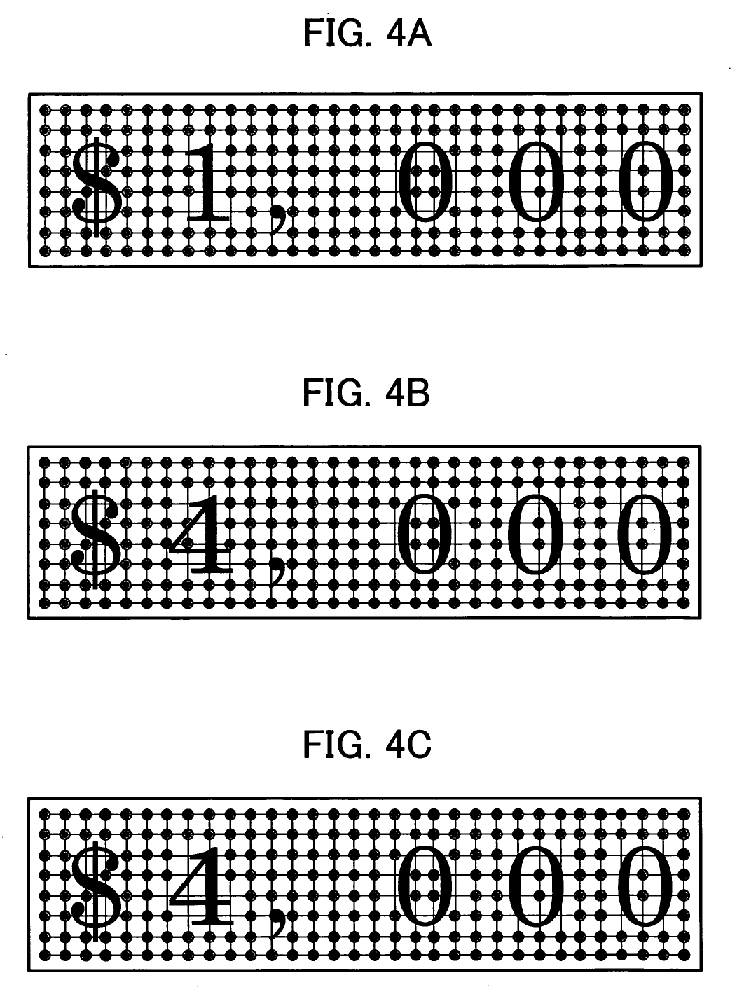

FIG. 3B is the document image shown in FIG. 3A with tamper-evident dots entirely added according to the above procedure. FIG. 4A is an enlarged view of a part of FIG. 3A showing tamper-evident dots added to the document image.

According to the following steps, fraudulent alteration can easily be checked for on the document image printed.

Given that the document shown in FIG. 3A has been tampered, i.e., a FIG. “1” shown in FIG. 4A has been transformed into “4” as shown in FIG. 4B in an amount on a bill “1,000”. FIG. 4B shows the exemplarily alternation. As shown in FIG. 4B, in the document tampered, several dots in background around the FIG. “1” are overlapped with additional lines of the FIG. “4” and apparently differ from the ones shown in FIG. 4A. It is therefore possible to visually distinguish whether the document has been changed. In order to keep the alternation unrevealed, it rises necessity in faking the FIG. “4” in FIG. 4B to erase several dots around the FIG. “1” where the dots are to be overlapped with additional parts of the FIG. “4”, as shown in FIG. 4C. On the contrary, in a case of erasing, for example, in erasing a figure on the document image, a spot where the figure had existed becomes a blank area. It thus raises necessity for adding dots onto the blank area in order to cover the change. It is practically impossible, however, to avoid having artificial appearance on a sheet of paper in eliminating toner fixed by a page printer, a laser printer, and so on, or ink fixed by a serial printer like ink-jet printer. Further, it is also difficult to add dots exhibiting similar appearance to the ones printed in the toner or ink. It is therefore virtually impossible to tamper the document without being revealed.

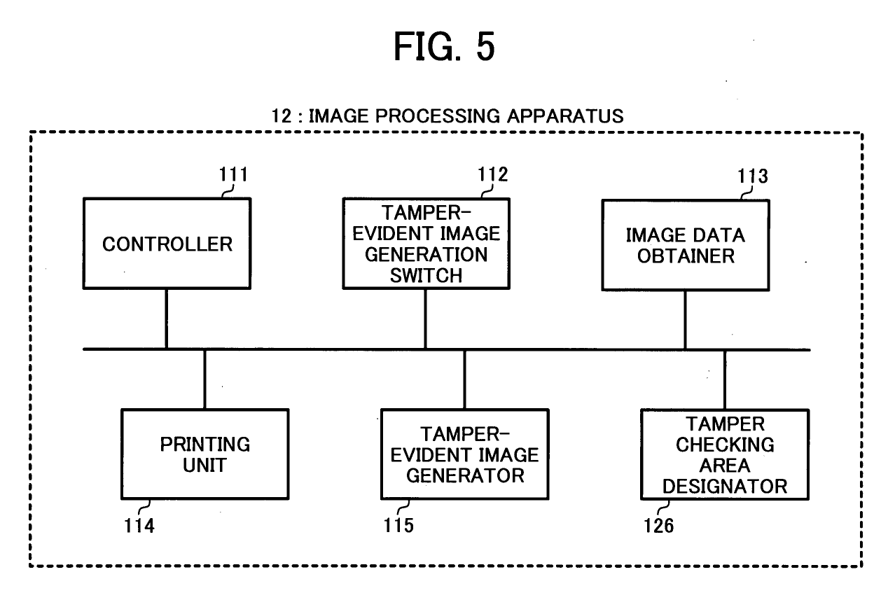

Next, an image processing apparatus 12 according to another embodiment of the present invention will be now described with reference to FIG. 5. The apparatus 12 of FIG. 5 adds a tamper-evident dotted pattern to specific parts of a document image, thereby allowing a visual checking for tampering on parts of the document image.

The image processing apparatus 12 is similar to the image processing apparatus 11 of FIG. 1, except for a tamper checking area designator 126.

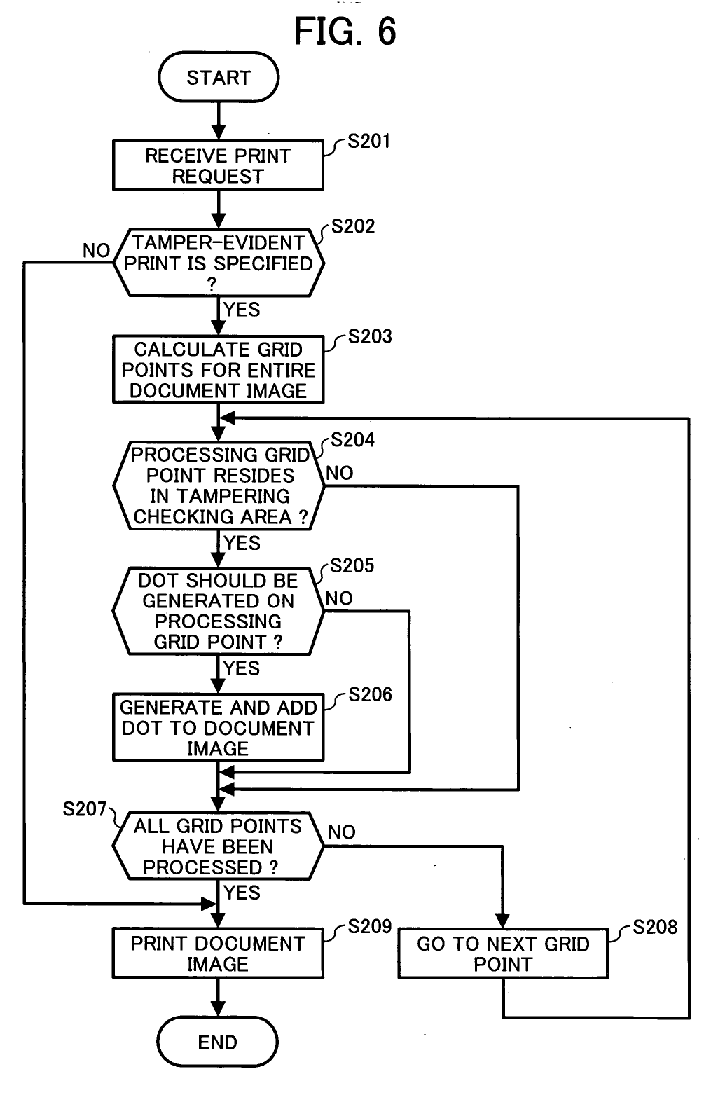

As shown in FIG. 6, the controller 111 receives a print request from a user in Step S201. The tamper-evident image generation switch 112 is able to set a command to the print request to print a tamper-evident image. The image data obtainer 113 obtains an image data to be processed. In Step S202, the controller 111 tests whether printing of a tamper-evident image is specified by the tamper-evident image generation switch 112.

When no specification is found to print the tamper-evident image, the operation proceeds to Step S209. In Step S209, the printing unit 114 prints the document image without an additional dotted image, and the operation proceeds to END.

When Step S202 determines to print the tamper-evident image, the operation proceeds to Step S203. In Step S203, the tamper-evident image generator 115 calculates positions of grid points in the document image and designates a grid point to be focused, and the operation proceeds to Step S204. When Step S204 determines that the grid point being processed resides in an area specified for tamper-checking, the operation proceeds to Step S205. In Step S205, the tamper-evident image generator 115 determines for the grid point being processed whether the grid point needs to be dotted. That is, when no image data exists on or close to the grid point, the tamper-evident image generator 115 determines to generate a dot on the grid point. In that case, the operation proceeds to Step S206 where the dot is added to the original document image. When there exists image data on or close to the grid point in Step S205, the tamper-evident image generator 115 determines as not to generate a dot on the grid point.

When the tamper-evident image generator 115 determines not to add the dot to the original image in Step S204, or an addition of the dot to the original image is completed in Step S206, the operation proceeds to Step S207. Step S207 tests whether all the grid points have been processed. When all the grid points have been processed, the operation proceeds to Step S209 to print the document image with an additional dot image, thereafter proceeds to END. In Step S207, when the process has not completed on all the grid points, the target moves to a next grid point, and the operation returns to Step S204.

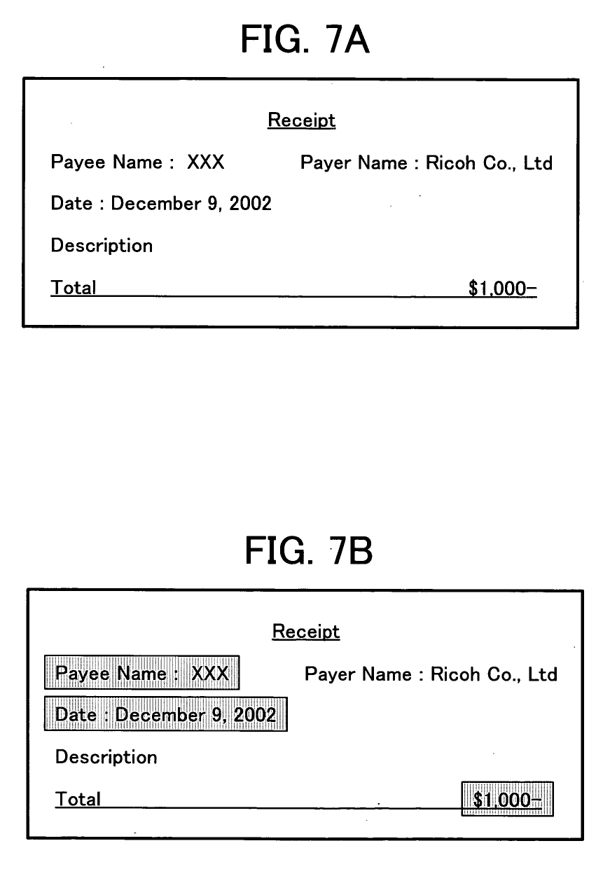

FIG. 7B is an example of a document image shown in FIG. 7A with tamper-evident dots added to several parts according to the procedure above. An enlarged view of a part of FIG. 7B is in common with FIG. 4A. An enlarged view of a part of the document image tampered is omitted as it is also in common with FIG. 4B.

In a manner similar to the steps described in the preceding embodiment, a fraudulent alteration can easily be checked for on the document image printed.

In the present embodiment, a procedure to check the alteration is in common with the procedure in the preceding embodiment. The present embodiment, however, restricts areas to be processed, thereby allowing more detailed and effective checking for alteration on a document image, with minimum setup to the original data.

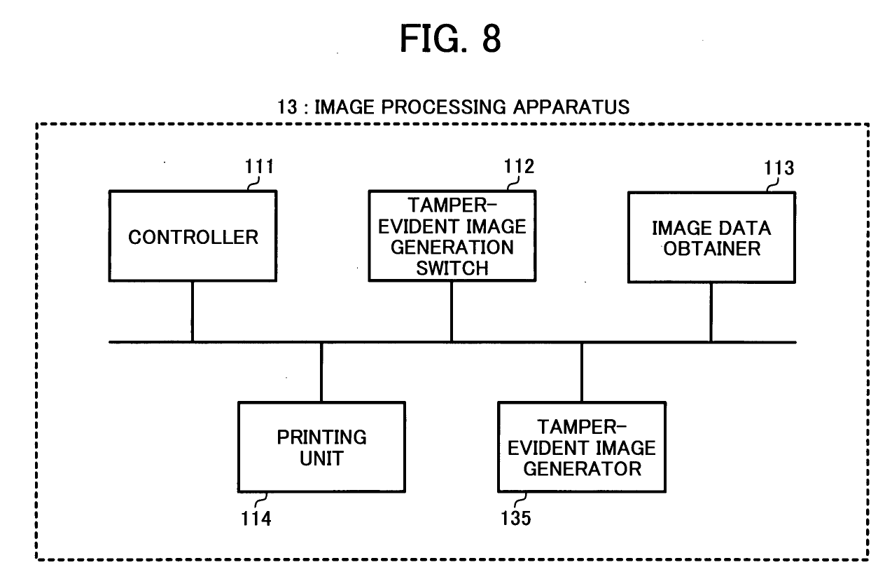

Next, an image processing apparatus 13 according to another embodiment of the present invention will be now described with reference to FIG. 8. In this embodiment, the image processing apparatus 13 adds a tamper-evident dotted pattern to a document image to be processed, thereby allowing automatic checking on the entire image for tampering.

The image processing apparatus 13 is similar to the image processing apparatus 11 of FIG. 1, except for functions of a tamper-evident image generator 135.

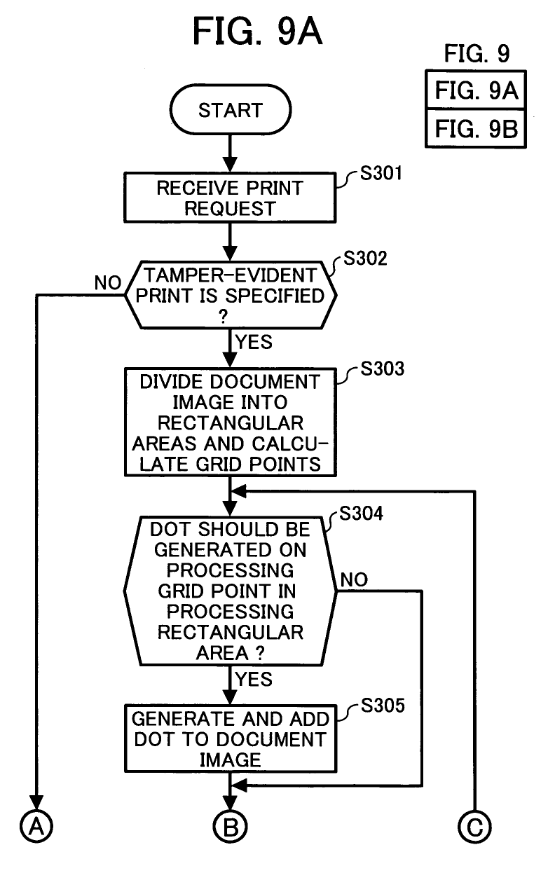

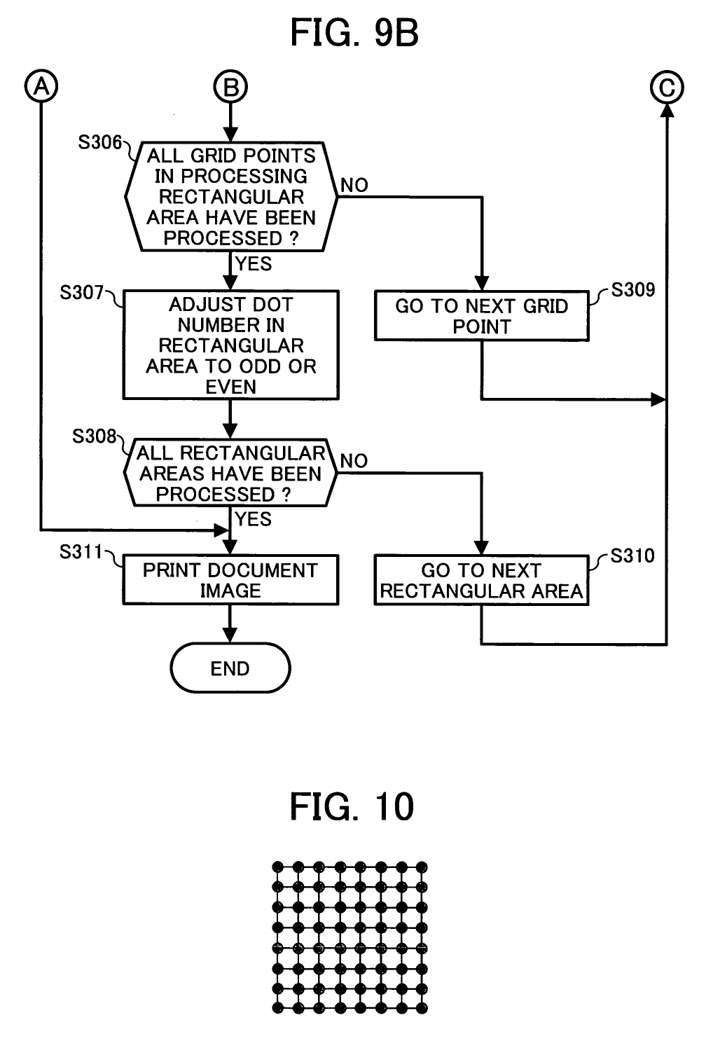

As shown in FIG. 9, the controller 111 receives a print request from a user in Step S301. The tamper-evident image generation switch 112 is able to set to the print request a command of printing a tamper-evident image. The image data obtainer 113 obtains image data to be processed. In Step S302, the controller 111 tests whether printing of a tamper-evident image is specified by the tamper-evident image generation switch 112.

When no specification is found to print the tamper-evident image, the operation proceeds to Step S311. In Step S311, the printing unit 114 prints the document image without an additional dotted image, and the operation proceeds to END.

When Step S302 determines to print the tamper-evident image, the operation proceeds to Step S303. In Step S303, the tamper-evident image generator 135 divides the document image into a plural of rectangular unit areas and calculates positions of grid points in each rectangular area, and designates a rectangular area and a grid point to be focused. Then the operation proceeds to Step S304. In Step S304, the tamper-evident image generator 135 determines for the processing grid point in the processing rectangular area whether the grid point needs to be dotted. That is, when no image data exists on or close to the grid point, the tamper-evident image generator 135 determines to generate a dot on the grid point. In that case, the operation proceeds to Step S305 where the dot is added to the original document image. When there exists image data on or close to the grid point in Step S304, the tamper-evident image generator 135 determines as not to generate a dot on the grid point.

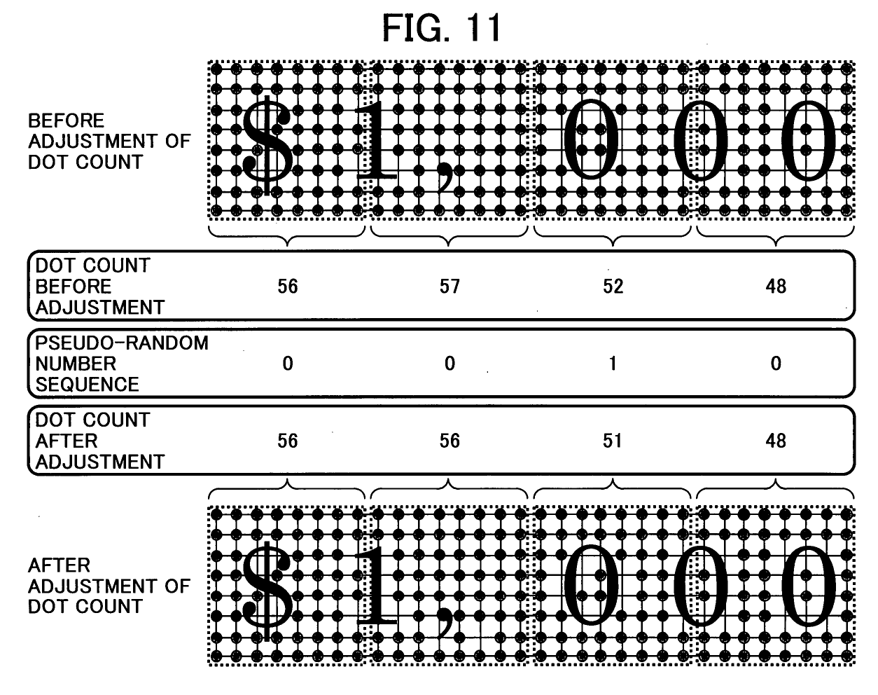

When the tamper-evident image generator 135 determines not to add the dot to the original image in Step S304, or an addition of the dot to the original image is completed in Step S305, the operation proceeds to Step S306. Step S306 tests whether all the grid points have been processed in the processing rectangular area. When the process has not completed on all the grid points in the processing rectangular area, the operation proceeds to Step S309 to move the target to a next grind point and then returns to Step S304. When all the grid points have been processed, the operation proceeds to Step S307. In Step S307, a dot number in the processing rectangular area is adjusted to be even or odd. More specifically, as shown in FIG. 10, a plurality of dots is initially generated to fill a rectangular area. In an example of FIG. 10 where 64 dots are generated, each dot is assigned onto each point of eight by eight matrix. In the meantime, a pseudo-random number of 0 or 1 is generated for each rectangular area. Then, a dot number in a rectangular area is adjusted to be even or odd, according to the value 0 or 1 of the pseudo-random number assigned, respectively, as shown in an example in FIG. 11. That is, when the dot number in the rectangular area is even and the pseudo-random number shows zero, or vise versa, the number of dots remains unchanged. On the contrary, when the dot number in the rectangular area is even and the pseudo-random number shows one, or vice versa, the tamper-evident image generator 135 deletes one dot to make the number of dots corresponding to the value of the pseudo-random number. It is also possible to predetermine the number of dots to constantly be even or odd in rectangular areas.

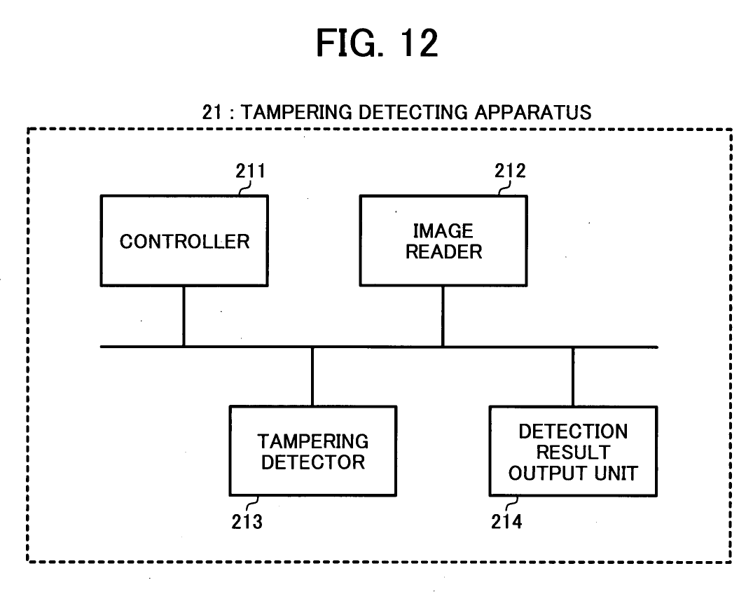

Referring to FIG. 12, a tampering detecting apparatus 21 of the present invention will now be described. In FIG. 12, a tampering detecting apparatus 21 includes a controller 211, an image reader 212, a tampering detector 213, and a detection result output unit 214. The controller 211 controls the tampering detecting apparatus 21 as a whole.

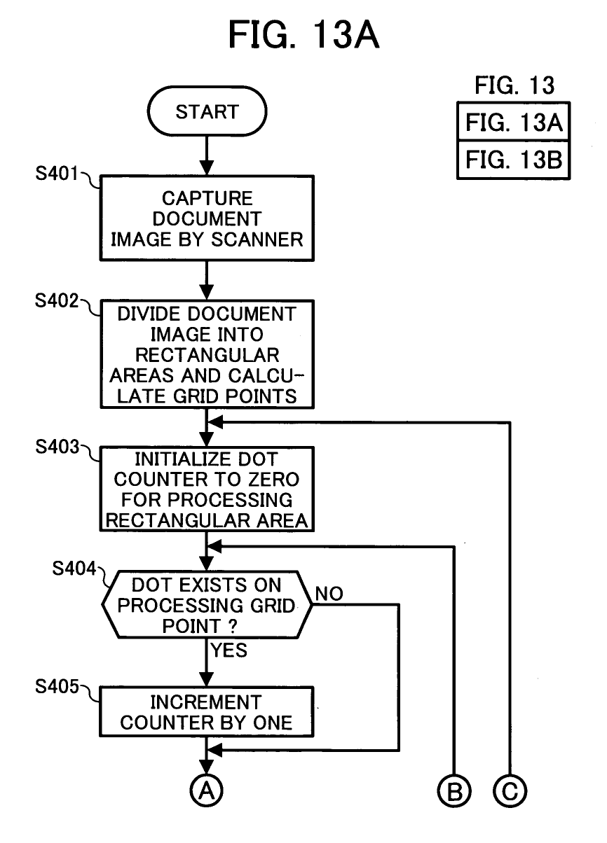

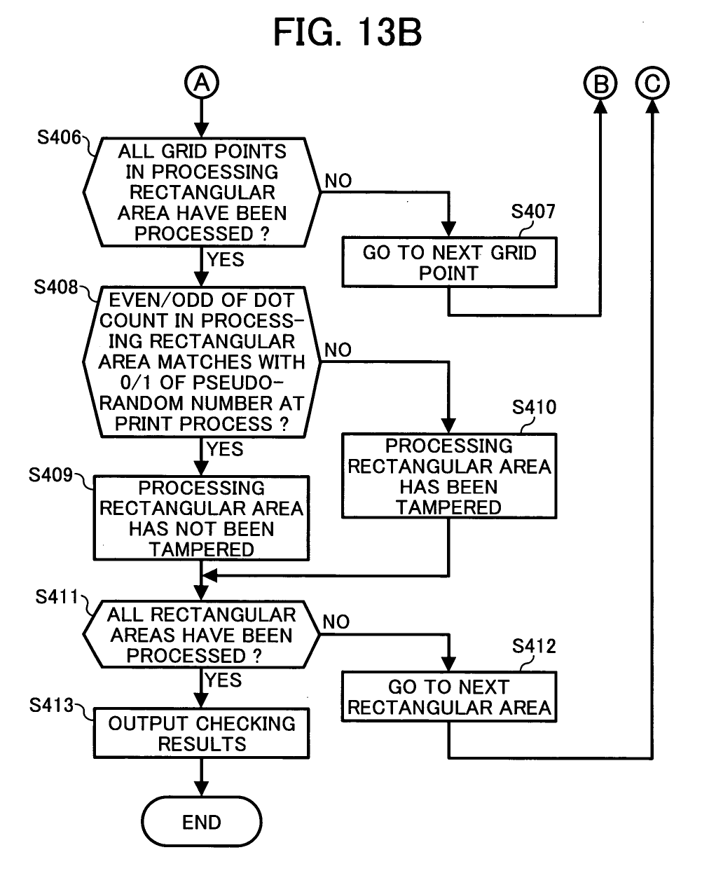

FIG. 13 is a flowchart showing an exemplary procedure of a tamper detecting operation performed by the tampering detecting apparatus 21 of FIG. 12. The tamper detecting operation is operated according to the following steps.

In Step S401, an image reader 212 scans a document with a scanner and captures the data scanned as a document image to be processed. Then, in Step S402, the document image is divided into a plurality of rectangular unit areas. In each rectangular area, positions of grid points are calculated. When it is known that the document image has been generated with the image processing apparatus 13 shown in FIG. 8, the positions of grid points are calculated according to specifications of grids, such as a distance between dots or a position of grid points, set to the image processing apparatus 13.

The tampering detector 213 is provided with a counter. In Step S403, the tampering detector 213 initializes the counter to zero for the processing rectangular area. In Step S404, the tampering detector 213 tests presence of a dot on the processing grid point in the rectangular area. When the test determines that there exists a dot on the grid point, the operation proceeds to Step S405. In Step S405, the tampering detector 213 increments the counter by one. When the test determines that no dot exists on the grid point, or when the process in Step S405 has completed, the operation proceeds to Step S406. In Step S406, the tampering detector 213 tests whether all grid points have been processed in the processing rectangular area. When all the grid points have not been processed, the operation proceeds to Step S407 where the target moves to a next grid point. When all the grid points have been processed in the processing rectangular area, the operation proceeds to Step S408. In Step S408, the tampering detector 213 tests whether even/odd of the number of dots corresponds to the value zero/one of the pseudo-random number used at printing the document image. When Step S408 determines the number of the dots corresponds to the value of the pseudo-random number, the operation proceeds to Step S409 which determines the rectangular area has no tampering. When Step S408 determines the number of the dots does not correspond to the value of the pseudo-random number, on the contrary, the operation proceeds to Step S410 which determines the rectangular area sustains tampering.

Then, Step S411 tests whether the tampering detector 213 has processed all the rectangular areas in the document image. When all the rectangular areas have been processed, the operation proceeds to Step S413. In Step S413, the detection result output unit 214 prints out the checking results which are determined individually for each rectangular area. Then the operation goes to END. When not all the rectangular areas have been processed in Step S411, the operation proceeds to Step S412 in which a target moves to a next rectangular area.

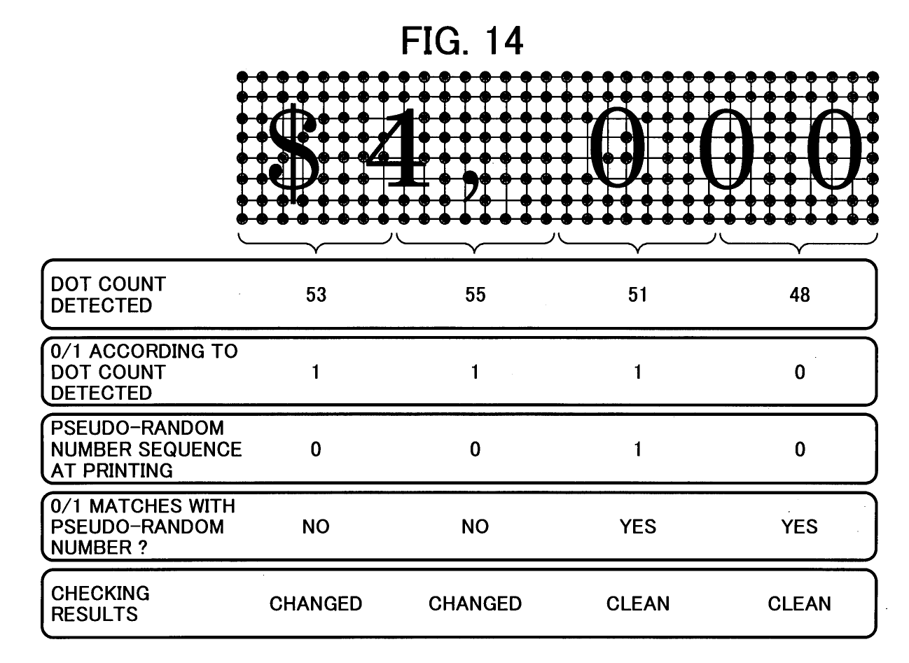

FIG. 14 shows a specific example of checking process for tampering according to the procedure described above. Since the tampering detecting apparatus 21 performs detection process of the document image per segment area, it is easy to locate a part on which change has been made, if any tampering is detected.

The tamper-evident image generators 115 and 135 according to the present invention may be configured to fill blank background areas of a document image with a predetermined pattern. The dotted pattern for background is formed with dots or lines which are large enough or wide enough to be recognized by an image reader. Whether the dotted pattern appears in a copy of the original document depends on a size of a dot a copier is able to recognize. The background dotted pattern is a specific arrangement of dots, such as a pattern formed with characters and the background filled with dots, for example.

The present invention allows to check for changes of a document printed on a normal sheet of paper with a normal laser printer or ink jet printer, not on special materials or with special ink. It is thus possible to provide a tamper-evident printed material with a low cost. The automatic detection of tampering with the printed matter performed by the tamper detecting apparatus 21 is especially preferable for apparatuses with copying function such as a copier or a facsimile.

This invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced otherwise than as specifically described herein.

What is claimed as new and desired to be protected by Letters Patent of the United States is:

1. An image processing apparatus, comprising:
an image obtainer configured to obtain image data of an image to be processed; and
a tamper-evident image generator configured to generate a tamper-evident image by filling the image obtained by said image data obtainer with dots arranged according to a predetermined pattern.

2. The apparatus of claim 1, further comprising:
an analyzer configured to analyze the image, wherein said tamper-evident image generator fills the image with said predetermined pattern based on results of said analyzer.

3. The apparatus of claim 2, wherein said tamper-evident image generator fills areas of blank background of the image with dots arranged according to said predetermined pattern based on results of said analyzer.

4. The apparatus of claim 1, wherein said predetermined pattern is a background dot pattern which forms a background of the image.

5. The apparatus of claim 1, further comprising:
a printer configured to print the tamper-evident image according to the image data generated by said tamper-evident image generator.

6. The apparatus of claim 1, further comprising:
a communicator configured to send the image data generated by said tamper-evident image generator to other apparatuses through one of a channel and a network.

7. The apparatus of claim 1, further comprising:
a switch configured to activate and deactivate operations of said tamper-evident image generator.

8. The apparatus of claim 1, wherein said tamper-evident image generator processes designated areas of the image.

9. The apparatus of claim 1, wherein said tamper-evident image generator is configured to perform an adjustment to change a number of dots in each unit dot area of the image to either one of predetermined numeric groups in generating said predetermined pattern, the image being segmented into a plurality of unit dot areas.

10. The apparatus of claim 9, wherein the adjustment is performed based on specific information.

11. The apparatus of claim 10, wherein the specific information includes a pseudo-random number.

12. The apparatus of claim 9, wherein the predetermined numeric groups include even and odd numeric groups.

13. A tampering detecting apparatus, comprising:
an image reader configured to read an image;
a tampering detector configured to divide the image read by said image reader into a plurality of unit areas, to count a number of dots existing in each of the plurality of unit areas, to test whether the dot number counted matches with a predetermined numeric group, and to determine whether each of the plurality of unit area is tampered based on result by the test; and
an output unit configured to output results of said tampering detector.

14. An image processing apparatus, comprising:
image obtaining means for obtaining image data of an image to be processed; and
tamper-evident image generating means for generating a tamper-evident image by filling the image obtained by said image data obtaining means with dots arranged according to a predetermined pattern.

15. The apparatus of claim 14, further comprising:
analyzing means for analyzing the image,
wherein said tamper-evident image generating means fills the image with said predetermined pattern based on results of said analyzing means.

16. The apparatus of claim 14, wherein said tamper-evident image generating means fills areas of blank background of the image with dots arranged according to said predetermined pattern.

17. The apparatus of claim 14, wherein said predetermined pattern is a background dot pattern which forms a background of the image.

18. The apparatus of claim 14, further comprising:
printing means for printing the tamper-evident image according to the image data generated by said tamper-evident image generating means.

19. The apparatus of claim 14, further comprising:
communication means for sending the image data generated by said tamper-evident image generating means to other apparatuses through one of a channel and a network.

20. The apparatus of claim 14, further comprising:
switching means for activating and deactivating operations of said tamper-evident image generating means.

21. The apparatus of claim 14, wherein said tamper-evident image generating means processes designated areas of the image.

22. The apparatus of claim 14, wherein said tamper-evident image generating means also performs an adjustment to change a number of dots in each unit dot area of the image to either one of predetermined numeric groups in generating said predetermined pattern, the image being segmented into a plurality of unit dot areas.

23. The apparatus of claim 22, wherein the adjustment is performed based on specific information.

24. The apparatus of claim 23, wherein the specific information includes a pseudo-random number.

25. The apparatus of claim 22, wherein the predetermined numeric groups include even and odd numeric groups.

26. A tampering detecting apparatus, comprising:
image reading means for reading an image;
tampering detecting means for dividing the image read by said image reading means into a plurality of unit areas, for counting a number of dots existing in each of the plurality of unit areas, for testing whether the dot number counted matches with a predetermined numeric group, and for determining whether each of the plurality of unit area is tampered based on result by the test; and
output means for outputting results of said tampering detection means.

27. An image processing method, comprising the steps of:
obtaining image data of an image to be processed; and
generating a tamper-evident image by filling the image obtained by said obtaining step with dots arranged according to a predetermined pattern.

28. The method of claim 27, further comprising the step of:
analyzing the image, wherein said tamper-evident image generating step fills the image with said predetermined pattern based on results of said analyzing step.

29. The method of claim 27, wherein said generating step fills areas of blank background of the image with dots arranged according to said predetermined pattern.

30. The method of claim 27, wherein said predetermined pattern is a background dot pattern which forms a background of the image.

31. The method of claim 27, further comprising the step of: printing the tamper-evident image according to the image data generated by said generating step.

32. The method of claim 27, further comprising the step of:
sending the image data generated by said generating step to apparatuses through one of a channel and a network.

33. The method of claim 27, further comprising the step of:
activating and deactivating operations of said generating step.

34. The method of claim 27, wherein said generating step processes designated areas of the image.

35. The method of claim 27, wherein said generating step also performs an adjustment to change a number of dots in each unit dot area in the image to either one of predetermined numeric groups in generating said predetermined pattern, the image being segmented into a plurality of unit dot areas.

36. The method of claim 35, wherein the adjustment is performed based on specific information.

37. The method of claim 36, wherein the specific information includes a pseudo-random number.

38. The method of claim 35, wherein the predetermined numeric groups include even and odd numeric groups.

39. A tampering detecting method, comprising the steps of:
reading an image;
detecting tampering in the image by
dividing the image read by said image reading step into a plurality of unit areas,
counting a number of dots existing in each of the plurality of unit areas,
testing whether the dot number counted matches with a predetermined numeric group, and
determining whether each of the plurality of unit area is tampered based on result by the testing; and
outputting results of said detecting step.

40. A computer program product stored on a computer readable storage medium for carrying out an image processing method, when run on an image processing apparatus, said method comprising steps of:
obtaining image data of an image to be processed; and
generating a tamper-evident image by filling the image obtained by said obtaining step with dots arranged according to a predetermined pattern.

41. The product of claim 40, wherein said method further comprises the step of analyzing the image, wherein said tamper-evident image generator fills the image with said predetermined pattern based on results of said analyzing step.

42. The product of claim 40, wherein said generating step fills areas of blank background of the image with dots arranged according to said predetermined pattern.

43. The product of claim 40, wherein said predetermined pattern is a background dot pattern which forms a background of the image.

44. The product of claim 40, wherein said method further comprises the step of printing the tamper-evident image according to the image data generated by said generating step.

45. The product of claim 40, wherein said method further comprises the step of sending the image data generated by said generating step to apparatuses through either one of a channel and a network.

46. The product of claim 40, wherein said method further comprises the steps of activating and deactivating operations of said generating step.

47. The product of claim 40, wherein said generating step processes designated areas of the image.

48. The product of claim 40, wherein said generating step also performs an adjustment to change a number of dots in each unit dot area of the image to either one of predetermined numeric groups in generating said predetermined pattern, the image being segmented into a plurality of unit dot areas.

49. The product of claim 48, wherein the adjustment is performed based on specific information.

50. The product of claim 49, wherein the specific information includes a pseudo-random number.

51. The product of claim 48, wherein the predetermined numeric groups include even and odd numeric groups.

52. A computer program product stored on a computer readable storage medium for carrying out a tampering detecting method, when run on a tampering detecting apparatus, said method comprising steps of:
reading an image;
detecting tampering in the image by
dividing the image read by said image reading step into a plurality of unit areas,
counting a number of dots existing in each of the plurality of unit areas,
testing whether the dot number counted matches with a predetermined numeric group, and
determining whether each of the plurality of unit area is tampered based on result by the testing; and
outputting results of said detecting step.

53. A computer readable medium storing computer instructions for performing an image processing method, said method comprising:
obtaining image data of an image to be processed; and
generating a tamper-evident image by filling the image obtained by said obtaining step with dots arranged according to a predetermined pattern.

54. The storage medium of claim 53, wherein said method further comprises analyzing the image, wherein said tamper-evident image generator fills the image with said predetermined pattern based on results of said analyzing step.

55. The storage medium of claim 53, wherein said generating step fills areas of blank background of the image with dots arranged according to said predetermined pattern.

56. The storage medium of claim 53, wherein said predetermined pattern is a background dot pattern which forms a background of the image.

57. The storage medium of claim 53, wherein said method further comprises printing the tamper-evident image according to the image data generated by said generating step.

58. The storage medium of claim 53, wherein said method further comprises sending the image data generated by said generating step to apparatuses through one of a channel and a network.

59. The storage medium of claim 53, wherein said method further comprises activating and deactivating operations of said generating step.

60. The storage medium of claim 53, wherein said generating step processes designated areas of the image.

61. The storage medium of claim 53, wherein said generating step also performs an adjustment to change a number of dots in each unit dot area of the image to either one of predetermined numeric groups in generating said predetermined pattern, the image being segmented into a plurality of unit dot areas.

62. The storage medium of claim 61, wherein the adjustment is performed based on specific information.

63. The storage medium of claim 62, wherein the specific information includes a pseudo-random number.

64. The storage medium of claim 61, wherein the predetermined numeric groups include even and odd numeric groups.

65. A computer readable medium storing computer instructions for performing a tampering detecting method, said method comprising:
reading an image;
detecting tampering in the image by
dividing the image read by said image reading step into a plurality of unit areas,
counting a number of dots existing in each of the plurality of unit areas,
testing whether the dot number counted matches with a predetermined numeric group, and
determining whether each of the plurality of unit area is tampered based on result by the testing; and
outputting results of said detecting step.
